(19) United States
(12) Patent Application Publication
(10) Pub. No.: US 2026/0353443 A1
(43) Pub. Date: Nov. 5, 2026

(54) PHYSICAL SIDELINK FEEDBACK CHANNEL OPPORTUNITY CONFIGURATIONS FOR UNLICENSED SIDELINK COMMUNICATIONS

(71) Applicant: QUALCOMM Incorporated, San Diego, CA (US)

(72) Inventors: Chih-Hao LIU, San Diego, CA (US); Jing SUN, San Diego, CA (US); Xiaoxia ZHANG, San Diego, CA (US); Stelios STEFANATOS, San Diego, CA (US); Giovanni CHISCI, San Diego, CA (US)

(21) Appl. No.: 19/102,677

(22) PCT Filed: Sep. 15, 2023
(86) PCT No.: PCT/US2023/032936

§ 371 Date: Feb. 10, 2025

(30) Foreign Application Priority Data
Sep. 20, 2022 (GR) 20220100768

(51) Int. Cl. H04W 74/0808; H04L 5/00; H04W 72/25

(52) U.S. Cl. CPC H04W 74/0808; H04L 5/0055; H04W 72/25

(57) ABSTRACT

Wireless communications systems, apparatuses, and methods are provided. A method of wireless communication performed by a first sidelink user equipment (UE) includes performing a listen-before-talk (LBT) procedure in an unlicensed frequency band and transmitting, to a second sidelink UE based on the LBT procedure being successful, an acknowledgement/negative acknowledgement (ACK/NACK) associated with a sidelink communication in at least one of a plurality of physical sidelink feedback channel (PSFCH) opportunities.

### CROSS-REFERENCE TO A RELATED APPLICATION

The present application claims priority to and the benefit of Greek Patent Application No. 20220100768, filed Sep. 20, 2022, the disclosure of which is referenced herein in its entirety as it fully set forth below and for all applicable purposes.

### TECHNICAL FIELD

This application relates to wireless communication systems, and more particularly, to physical sidelink feedback channel (PSFCH) opportunity configurations for unlicensed sidelink communications.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a first sidelink user equipment (UE), may include performing a listen-before-talk (LBT) procedure in an unlicensed frequency band and transmitting, to a second sidelink UE based on the LBT procedure being successful, an acknowledgement/negative acknowledgement (ACK/NACK) associated with a sidelink communication in at least one of a plurality of physical sidelink feedback channel (PSFCH) opportunities.

In an additional aspect of the disclosure, a method of wireless communication performed by a first sidelink user equipment (UE) may include transmitting, to one or more sidelink UEs in an unlicensed frequency band, a sidelink communication and monitoring, in at least one of a plurality of physical sidelink feedback channel (PSFCH) opportunities, for an acknowledgement/negative acknowledgement (ACK/NACK) associated with the sidelink communication.

In an additional aspect of the disclosure, a first sidelink user equipment (UE) may include a memory; a transceiver; and at least one processor coupled to the memory and the transceiver, wherein the first sidelink UE is configured to perform a listen-before-talk (LBT) procedure in an unlicensed frequency band and transmit, to a second sidelink UE based on the LBT procedure being successful, an acknowledgement/negative acknowledgement (ACK/NACK) associated with a sidelink communication in at least one of a plurality of physical sidelink feedback channel (PSFCH) opportunities.

In an additional aspect of the disclosure, a first sidelink user equipment (UE) may include a memory; a transceiver; and at least one processor coupled to the memory and the transceiver, wherein the first sidelink UE is configured to transmit, to one or more sidelink UEs in an unlicensed frequency band, a sidelink communication; and monitor, in at least one of a plurality of physical sidelink feedback channel (PSFCH) opportunities, for an acknowledgement/negative acknowledgement (ACK/NACK) associated with the sidelink communication.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates an example of resources associated with multiple PSFCH opportunities according to some aspects of the present disclosure.

FIG. 4 illustrates a wireless communication network according to some aspects of the present disclosure.

FIG. 5 illustrates a signal flow diagram for multiple PSFCH opportunities according to some aspects of the present disclosure.

FIG. 6 is a block diagram of an exemplary user equipment (UE) according to some aspects of the present disclosure.

FIG. 7 is a block diagram of an exemplary network unit according to some aspects of the present disclosure.

FIG. 8 is a flow diagram of a communication method according to some aspects of the present disclosure.

FIG. 9 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3^{rd} Generation Partnership Project” (3GPP), and cdma2000 is described in documents from an organization named “3^{rd} Generation Partnership Project 2” (3GPP2). These various radio technologies and standards are known or are being developed. For example, the 3^{rd} Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ~1M nodes/km2), ultra-low complexity (e.g., ~10 s of bits/sec), ultra-low energy (e.g., ~10+years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 ms), and users with wide ranges of mobility or lack thereof; and (3) with enhanced mobile broadband including extreme high capacity (e.g., ~10 Tbps/km2), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mm Wave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about at least 70 percent (%).

Some sidelink systems may operate over a 20 MHz bandwidth, e.g., for listen before talk (LBT) based channel accessing, in an unlicensed band. A BS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannel) in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (Rus)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more Rus. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

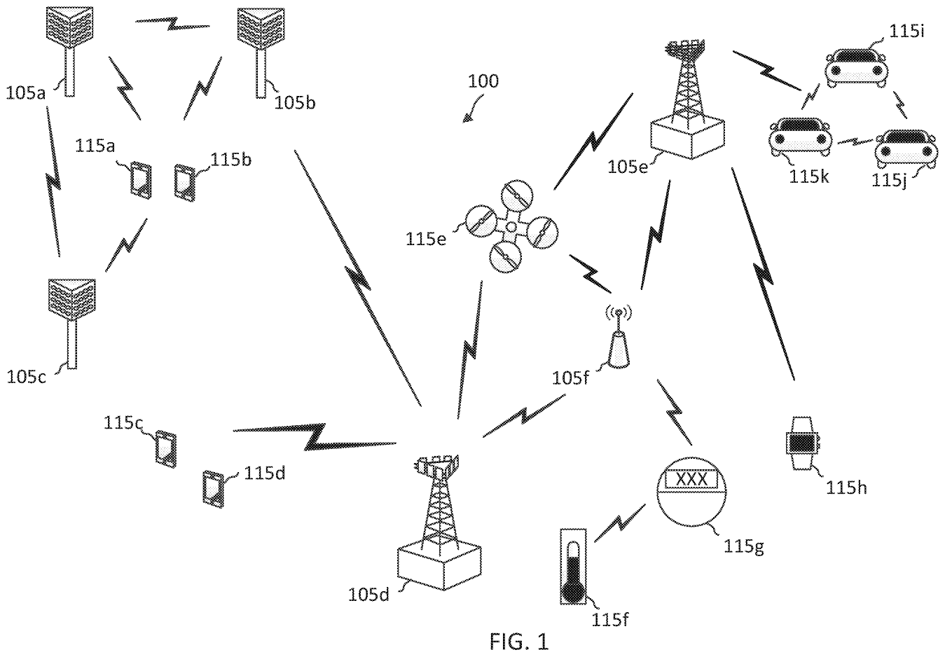

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105 a-105c may serve the UEs 115 a and 115 b using 3D beamforming and coordinated spatial techniques, such as coordinated multipoint (COMP) or multi-connectivity. The macro BS 105d may perform backhaul communications with the BSs 105a-105c , as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure.

For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the UE 115a may perform a listen-before-talk (LBT) procedure in an unlicensed frequency band. The UE 115a may transmit an acknowledgement/negative acknowledgement (ACK/NACK) to the UE 115a based on the LBT procedure being successful. The ACK/NACK may be associated with a sidelink communication received from the UE 115b. The UE 115a may transmit the ACK/NACK in at least one of a plurality of physical sidelink feedback channel (PSFCH) opportunities.

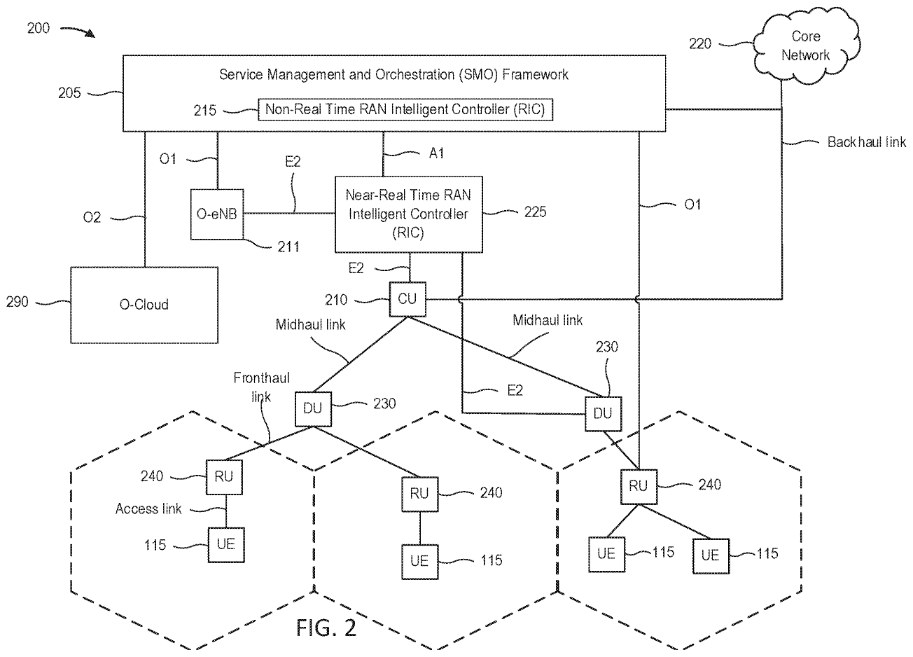

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (Rus) 240 via respective fronthaul links. The Rus 240 may communicate with respective UEs 115 via one or more radio frequency (RF) access links. In some implementations, the UE 115 may be simultaneously served by multiple Rus 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units.

Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like.

Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more Rus 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, Rus 240 and Near-RT RICs 225. In some implementations, the SMO Framework 205 can communicate with a hardware aspect of a 4G RAN, such as an open eNB (O-eNB) 211, via an Ol interface. Additionally, in some implementations, the SMO Framework 205 can communicate directly with one or more Rus 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as Al policies).

In some aspects, a first UE 115 may perform a listen-before-talk (LBT) procedure in an unlicensed frequency band. The first UE 115 may transmit an acknowledgement/negative acknowledgement (ACK/NACK) to a second UE 115 based on the LBT procedure being successful. The ACK/NACK may be associated with a sidelink communication received from the second UE 115. The first UE 115 may transmit the ACK/NACK in at least one of a plurality of physical sidelink feedback channel (PSFCH) opportunities.

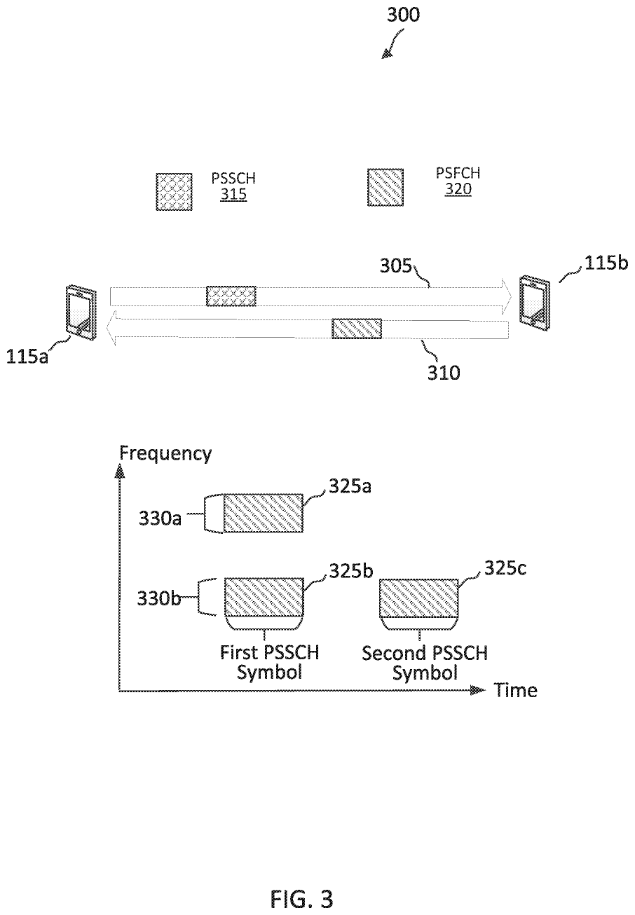

FIG. 3 illustrates a wireless communication network 300 according to some aspects of the present disclosure. FIG. 3 illustrates an example of a wireless communications system 300 that supports techniques for configuring multiple PSFCH opportunities for sidelink feedback in accordance with various aspects of the present disclosure. The wireless communications system 300 illustrates communication between a UE 115a and a UE 115b, which may be examples of corresponding devices described herein, including UEs 115 as described with reference to FIGS. 1 and 2. In some aspects, the UE 115a and the UE 115b may communicate within a geographic coverage area and communicate with each other via a communication link 305 and a communication link 310 operating in sidelink mode. In some implementations, the UE 115b may receive a configuration of multiple PSFCH opportunities 325 over multiple LBT sub-bands 330 and symbols corresponding to a PSSCH 315.

The wireless communications system 300, which may be an example of an NR system supporting NR sidelink communication, such as V2X communication, may support the transmission of feedback (such as HARQ feedback) over a PSFCH 320 for higher reliability for both unicast and groupcast transmissions. For example, the UE 115a or the UE 115b, or both, may transmit a HARQ response (such as an ACK or a NACK) over a PSFCH opportunity 325 responsive to sidelink communication between the UE 115a and the UE 115b, and the PSFCH may be arranged or otherwise configured as a global resource pool with pre-determined (e.g., pre-configured) mappings or assignments. In other words, in some cases, there may be multiple PSFCH opportunities 325 for one PSSCH. Such examples in which there may be a multiple PSFCH opportunities 325 for one PSSCH may include examples of unicast HARQ response (such that one UE 115 receives a data transmission and transmits feedback via PSFCH responsive to the data transmission and examples of groupcast HARQ response option 2 (such that multiple UEs 115 receive a data transmission and each transmit or refrain from transmitting a PSFCH 320 responsive to the data transmission).

In some aspects, one or more PSFCH opportunities 325 are mapped or assigned to one PSSCH 315 and in which the UE 115a transmits a data transmission to the UE 115b over a PSSCH 315, the UE 115b may determine the PSFCH opportunities 325 that are mapped or assigned to the PSSCH 315 over which the UE 115a transmits the data transmission, and the UE 115b may transmit ACK/NACK feedback responsive to the data transmission over one or more PSFCH opportunities 325 accordingly. In some cases, such a mapping or assignment may be pre-configured for each PSSCH 315 resource over which a UE 115 may transmit.

In some aspects, each PSSCH 315 may be mapped to multiple PSFCH opportunities 325, and each different PSFCH opportunity 325 may correspond to a different set of physical resource blocks (PRBs) in a symbol period, such as a PSFCH symbol period. In some cases, each set of PRBs in the PSFCH symbol period may include a configurable quantity of PRBs.

In some aspects, the UE 115a and the UE 115b may communicate over an unlicensed radio frequency spectrum band. In such cases in which the UE 115a and the UE 115b communicate over an unlicensed radio frequency spectrum band, the UE 115a and the UE 115b may perform LBT (e.g., an LBT procedure or a channel access procedure) prior to transmitting to support coexistence with other radio access technologies (RATs). In some aspects, the UE 115b may perform an LBT prior to transmitting the ACK/NACK feedback (e.g., a HARQ response) over one or more PSFCH opportunities 325. In some cases, however, the PSFCH opportunity 325 may be occupied or otherwise unavailable such that the LBT for the PSFCH opportunity 325 may fail. As such, the UE 115b may be unable to gain channel access for the PSFCH opportunity 325 and may be unable to transmit the ACK/NACK to the UE 115a over the PSFCH opportunity 325. The UE 115a, failing to receive the ACK/NACK feedback from the UE 115b over the PSFCH opportunity 325 corresponding to (e.g., mapped or assigned to) the PSSCH 315 carrying the data transmission, may determine or otherwise assume that the UE 115b failed to successfully receive the data transmission. The UE 115a may accordingly re-transmit the data transmission to the UE 115b over a second PSSCH 315, which may be unnecessary in cases in which the UE 115b successfully received the initial data transmission and experienced an LBT failure when attempting to transmit the associated ACK/NACK feedback. Aspects of the present disclosure provide multiple PSFCH opportunities 325 in the time domain and/or frequency domain to increase the probability of the LBT passing and the PSFCH being transmitted to the UE 115a.

In some aspects, the UE 115b may receive a configuration of multiple PSFCH opportunities 325, such as a PSFCH opportunity 325a, a PSFCH opportunity 325b, and a PSFCH opportunity 325c, over multiple LBT sub-bands 330, such as over an LBT sub-band 330a and an LBT sub-band 330b. In other words, one PSSCH over which the UE 115a may transmit the data transmission to the UE 115b (and that requests HARQ response) may correspond to multiple PSFCH opportunities 325 over multiple LBT sub-bands 330 and/or multiple symbols.

For example, the UE 115a may transmit the data transmission over a PSSCH 315 that corresponds to multiple PSFCH opportunities 325 including the PSFCH opportunity 325a located in the LBT sub-band 330a and in a first PSFCH symbol, the PSFCH opportunity 325b located in the LBT sub-band 330b and in the first PSFCH symbol, and the PSFCH opportunity 325c located in the LBT sub-band 330b and in a second PSFCH symbol. As such, the UE 115b may perform an LBT procedure for one or more of the PSFCH opportunities 325 to determine which of the multiple PSFCH opportunities 325 are available (e.g., which of the multiple PSFCH opportunities 325 pass LBT). In some aspects, the UE 115b may determine that one or more of the multiple PSFCH opportunities 325 are available (e.g., pass LBT) and may transmit the ACK/NACK associated with the data transmission over at least one of the one or more PSFCH opportunities 325 that are available.

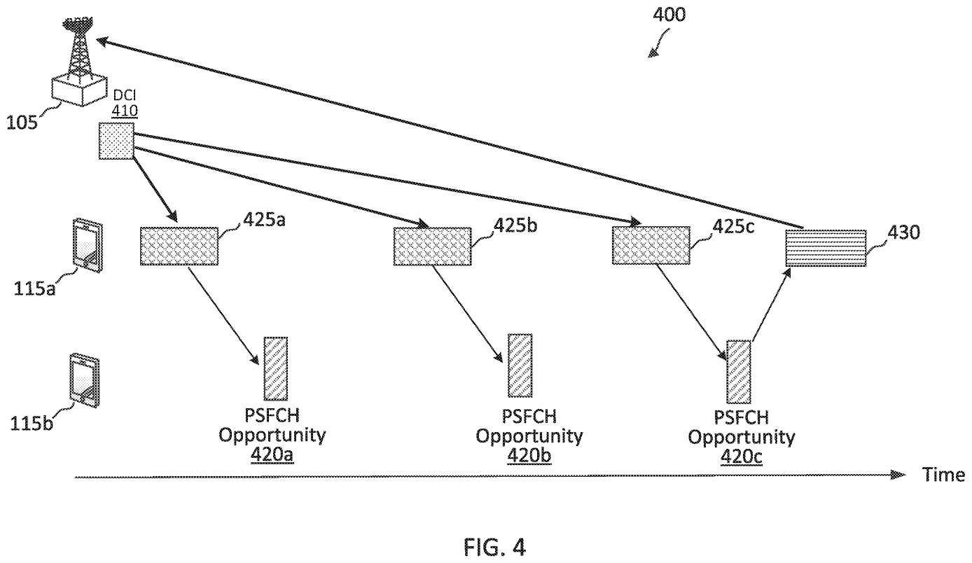

FIG. 4 illustrates a wireless communication network 400 according to some aspects of the present disclosure. Wireless communication network 400 may include network unit 105, UE 115a, and UE 115b. In some aspects, UE 115a may transmit a sidelink communication 425 to UE 115b. In response, the UE 115b may transmit an ACK/NACK over one or more PSFCH opportunities 420 to the UE 115a. The ACK/NACK may indicate whether the sidelink communication was successfully received by the UE 115b. The UE 115b may perform a listen-before-talk (LBT) procedure in an unlicensed frequency band before transmitting the ACK/NACK. The UE 115b may perform the LBT procedure or other clear channel assessment (CCA) on one or more sidelink communication channels. In some instances, the UE 115b may perform an LBT procedure or other CCA to gain access to a channel occupancy time (COT) in an unlicensed (e.g., shared) frequency spectrum. For example, the UE 115b may perform a category 1 LBT, a category 2 LBT, a category 3 LBT, and/or a category 4 LBT to gain access to the COT in the unlicensed frequency spectrum. In some aspects, the UE 115b may perform the LBT in one or more time resources, spatial resources, and/or frequency resources to gain access to a channel within one or more PSFCH opportunities 420. The frequency resources may include a frequency spectrum, a frequency band, a frequency sub-band, a frequency subchannel, resource elements, resource blocks, and/or a frequency interlace. The time resources may include slot(s), sub-slot(s), symbol(s), subframe(s), or any other suitable time resources. In some aspects, the UE 115b may perform the LBT for one or more directional beams (e.g., a beam in the direction of the UE 115a that the UE 115b intends to transmit an ACK/NACK).

In some aspects, the UE 115b may transmit the ACK/NACK to the UE 115a in the earliest PSFCH opportunity 420a of the plurality of PSFCH opportunities 420 in which the LBT is successful. The UE 115b may transmit the ACK/NACK in the earliest PSFCH opportunity 420a in order to reduce the latency in transmitting feedback to the UE 115a (e.g., the UE that transmitted the PSSCH 425 to the UE 115b). In some aspects, the UE 115a may have multiple opportunities (e.g., up to two opportunities or more) to retransmit the PSSCH communication 425 if the UE 115a does not receive an ACK associated with the PSSCH communication 425 from the UE 115b. For example, the UE 115a may transmit the initial PSSCH communication in PSSCH 425a. The PSSCH 425b and 425c may be opportunities for retransmission of the PSSCH communication. The UE 115a may not receive an ACK associated with the PSSCH communication 425 from the UE 115b based on the LBT performed by the UE 115b not being successful, the UE 115b transmitting a NACK to the UE 115a (e.g., transmitting a NACK in PSFCH opportunities 420a and 420b), and/or the ACK/NACK transmitted by the UE 115b is not correctly received and decoded by the UE 115a. In some aspects, multiple PSFCH opportunities 420 may increase the probability of the UE 115a receiving the ACK/NACK. For example, the UE 115b may transmit the ACK/NACK in the earliest PSFCH opportunity that passes the LBT (e.g., PSFCH opportunity 420a) and in the next (e.g., the following) PSFCH opportunity (e.g., PSFCH opportunity 420b) that passes the LBT. Additionally or alternatively, the UE 115b may transmit the ACK/NACK in a plurality of sub-bands (e.g., subchannels) of the unlicensed frequency band that passes the LBT. A sub-band may refer to or include a frequency bandwidth over which the UE 115b may perform an LBT procedure. For instance, in examples in which the UE 115 b and the UE 115 a communicate over the 5 GHz unlicensed radio frequency spectrum band, a sub-band may refer to or include a 20 MHz frequency range or other suitable frequency range.

In some aspects, the UE 115b may transmit the ACK/NACK to the UE 115a in all of the PSFCH opportunities 420 of the plurality of PSFCH opportunities 420 in which the UE 115b performs a successful LBT. The UE 115b may increase the probability of the UE 115a successfully receiving and decoding the ACK/NACK based on transmitting the ACK/NACK in all of the PSFCH opportunities 420 that pass the LBT. In some aspects, the UE 115a may combine multiple ACK/NACK transmissions from the UE 115b to successfully decode the ACK/NACK.

In some aspects, the UE 115b may receive a configuration indicating parameters associated with the plurality of PSFCH opportunities. The UE 115b may receive the configuration from the UE 115a and/or the network unit 105. The configuration may indicate the number of PSFCH opportunities 420, the time resources associated with the plurality of PSFCH opportunities 420, the frequency resources associated with the plurality of PSFCH opportunities 420, and other suitable parameters associated with the plurality of PSFCH opportunities 420. In this regard, the UE 115b may receive the configuration from the UE 115a via at least one of a radio resource control (RRC) message, a medium access control control element (MAC-CE), sidelink control information (SCI), or other suitable communication. Additionally or alternatively, the UE 115b may receive the configuration from the network unit 105 via at least one of a radio resource control (RRC) message, downlink control information (DCI) 410, a medium access control control element (MAC-CE), or other suitable communication.

In some aspects, the configuration may include a default configuration indicating parameters associated with the plurality of PSFCH opportunities 420. The default configuration may be adjusted (e.g., updated over time) based on parameters including, without limitation, an LBT procedure success rate, an interference level associated with the unlicensed frequency band, a buffer status report (BSR) associated with the UE 115a, a data type associated with the sidelink PSSCH communication 425, a priority level associated with the sidelink PSSCH communication 425, or other suitable parameter(s).

In some aspects, the UE 115b may receive an indicator indicating a subset of number of the plurality of PSFCH opportunities 420. The UE 115b may receive the indicator from the UE 115a and/or the network unit 105. The default configuration may include a default number of PSFCH opportunities 420 and their associated time/frequency resources. The UE 115b may subsequently receive the indicator indicating the subset of the PSFCH opportunities 420. The UE 115b may transmit the ACK/NACK in the subset of PSFCH opportunities 420. The subset may be based on the parameters indicated above. For example, the UE 115b may measure an LBT success rate. The LBT success rate may indicate the number of times an attempted LBT is successful over a time period. The LBT success rate may reflect the level of interference/activity in the unlicensed frequency band. The UE 115b may transmit the LBT success rate indicator to the UE 115a and/or the network unit 105. The UE 115a and/or the network unit 105 may transmit the subset of the PSFCH opportunities 420 and their associated time/frequency resources to the UE 115b via at least one of a RRC message, a MAC-CE message, DCI 410, SCI, or other suitable communication.

In some aspects, the subset of the PSFCH opportunities 420 may be based on a data type associated with the PSSCH communication 425. The data type associated with the PSSCH communication 425 may include enhanced mobile broadband data, V2X data, massive machine type communications (mMTC) data, ultra-reliable low-latency communication (URLLC) data, and/or other types of data. The UE 115a may transmit the data type associated with the PSSCH communication 425 to the network unit 105. The network unit 105 may transmit the indicator of the subset of PSFCH opportunities 420 and their associated time/frequency resources based on the data type to the UE 115a via at least one of a RRC message, a MAC-CE message, DCI 410, or other suitable communication. The UE 115a may transmit the indicator of the subset of PSFCH opportunities 420 and their associated time/frequency resources to the UE 115b via at least one of a RRC message, a MAC-CE message, SCI, or other suitable communication.

In some aspects, the subset of PSFCH opportunities 420 may be based on a priority level associated with the PSSCH communication 425. The priority level associated with the PSSCH communication 425 may be based on a latency requirement and/or a reliability requirement associated with the PSSCH communication 425. The UE 115a may transmit the priority level associated with the PSSCH communication 425 to the network unit 105. The network unit may transmit an indicator of the subset of PSFCH opportunities 420 and their associated time/frequency resources based on the priority level to the UE 115a via at least one of a RRC message, a MAC-CE message, DCI 410, or other suitable communication. The UE 115a may transmit the indicator of the subset of PSFCH opportunities 420 and their associated time/frequency resources to the UE 115b via at least one of a RRC message, a MAC-CE message, SCI, or other suitable communication.

In some aspects, the UE 115b may receive and decode the PSSCH communication 425a from the UE 115a in a first slot. The UE 115b may perform an unsuccessful LBT at the next PSFCH opportunity 420a after decoding the PSSCH communication 425a thereby preventing the UE 115b from transmitting an ACK to the UE 115a. In response to not receiving an ACK from the UE 115b during PSFCH opportunity 420a, the UE 115a may retransmit the PSSCH communication 425b to the UE 115b. The UE 115b may recognize the PSSCH communication 425b as a retransmission and refrain from decoding the retransmitted PSSCH communication 425b thereby reducing power consumption and computing resources. The UE 115b may perform an LBT at the next PSFCH opportunity 420b after the retransmission of the PSSCH communication 425b. If the LBT is successful at the next PSFCH opportunity 420b, the UE 115b may transmit the ACK to the UE 115a. If the UE 115a successfully decodes the ACK, the UE 115a may refrain from retransmitting the PSSCH again in PSSCH 425c. If the UE 115a does not successfully decode the ACK, the UE 115a may retransmit the PSSCH communication again in PSSCH 425c.

In some aspects, the UE 115b may receive the ACK/NACK from the UE 115a in one or more of the PSFCH opportunities 420. The UE 115b may then transmit the ACK/NACK in a HARQ process to the network unit 105 in uplink communication 430. In some aspects, the UE 115b may transmit the ACK/NACK to the network unit 105 in uplink communication 430 after the last PSFCH opportunity 420c of the plurality of PSFCH opportunities 420. In some aspects, the UE 115b may transmit the ACK/NACK to the network unit 105 after time period (e.g., a HARQ processing time period) following the earliest PSFCH opportunity 420a of the plurality of PSFCH opportunities 420.

In some aspects, the UE 115a may transmit the sidelink communication to a group of sidelink UEs including the UE 115b as a groupcast sidelink communication. In this case, the UE 115b of the group of sidelink UEs may be configured to transmit a NACK to the UE 115a only if the UE 115b does not successfully decode the sidelink communication. The UE 115b may refrain from transmitting an ACK if the UE 115b successfully decodes the sidelink communication. In this way, the UE 115a may know that the group of sidelink UEs have successfully decoded the sidelink communication based on not receiving any NACKs. The UE 115b may transmit an ACK to the network unit 105 in uplink communication 430 when the UE 115b does not receive a NACK from any of the sidelink UEs in the groupcast.

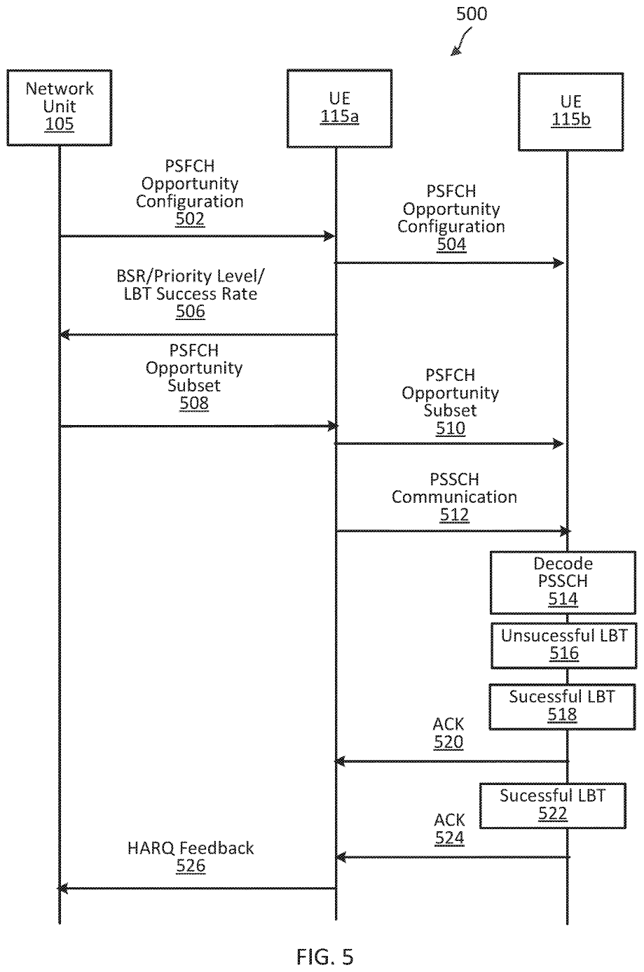

FIG. 5 is a signaling diagram of a wireless communication method 500 according to some aspects of the present disclosure. Actions of the communication method 500 can be executed by a computing device (e.g., a processor, processing circuit, and/or other suitable component) of a communication device or other suitable means for performing the actions. For example, a wireless communication device, such as the UE 115 or UE 600, may utilize one or more components, such as the processor 602, the memory 604, the PSFCH opportunity module 608, the transceiver 610, the modem 612, and the one or more antennas 616, to execute aspects of method 500. A wireless communication device, such as the network unit 105 or 700, may utilize one or more components, such as the processor 702, the memory 704, the PSFCH opportunity module 708, the transceiver 710, the modem 712, and the one or more antennas 716, to execute aspects of method 500.

At action 502, the network unit 105 may transmit a PSFCH opportunity configuration to the UE 115a. In this regard, the network unit 105 may transmit the configuration of PSFCH opportunities and their associated time/frequency resources the UE 115a via at least one of a RRC message, a MAC-CE message, DCI, or other suitable communication.

At action 504, the UE 115a may transmit the configuration of PSFCH opportunities and their associated time/frequency resources to the UE 115b via at least one of a RRC message, a MAC-CE message, SCI, or other suitable communication.

At action 506, the UE 115a may transmit at least one of an LBT procedure success rate, an interference level associated with the unlicensed frequency band, a buffer status report (BSR) associated with the UE 115a, a data type associated with a sidelink communication, a priority level associated with a sidelink communication, or other suitable parameter(s) to the network unit 105 via uplink control information (UCI), a PUCCH communication, a PUSCH communication, or other suitable communication.

At action 508, the network unit 105 may transmit an indicator of a subset of PSFCH opportunities to the UE 115a. In this regard, the network unit 105 may transmit the subset of PSFCH opportunities and their associated time/frequency resources to the UE 115a via at least one of a RRC message, a MAC-CE message, DCI, or other suitable communication. The subset of PSFCH opportunities may be based on the LBT procedure success rate, the interference level associated with the unlicensed frequency band, the buffer status report (BSR) associated with the UE 115a, the data type associated with the sidelink communication, the priority level associated with the sidelink communication, or other suitable parameter(s) transmitted to the network unit 105 at action 506.

At action 510, the UE 115a may transmit the indicator of the subset of PSFCH opportunities to the UE 115b. In this regard, the UE 115a may transmit the indicator of the subset of PSFCH opportunities to the UE 115b via at least one of a radio resource control (RRC) message, a medium access control control element (MAC-CE), sidelink control information (SCI), or other suitable communication.

At action 512, the UE 115a may transmit a PSSCH communication to the UE 115b. The PSSCH communication may be associated with a HARQ process in which the UE 115a monitors for ACK/NACK feedback from the UE 115b.

At action 514, the UE 115b may successfully decode the PSSCH transmitted by the UE 115a at action 512.

At action 516, the UE 115b may perform an unsuccessful LBT. The UE 115b may perform the LBT in an attempt to transmit the ACK/NACK feedback to the UE 115a. The UE 115b may perform the unsuccessful LBT in a PSFCH of the subset of PSFCH opportunities received at action 510.

At action 518, the UE 115b may perform a successful LBT. The UE 115b may perform the LBT in an attempt to transmit the ACK/NACK feedback to the UE 115a after failing the LBT at action 516. The UE 115b may perform the LBT in a next PSFCH of the subset of PSFCH opportunities after the PSFCH opportunity at action 516.

At action 520, the UE 115b may transmit an ACK to the UE 115a indicating successful decoding of the PSSCH communication transmitted to the UE 115b at action 512. The UE 115b may transmit the ACK to the UE 115a based on the successful LBT at action 518.

At action 522, the UE 115b may perform another successful LBT. The UE 115b may perform the LBT in an attempt to retransmit the ACK/NACK feedback to the UE 115a. The UE 115b may perform the LBT in a next PSFCH of the subset of PSFCH opportunities after the PSFCH opportunity at action 518.

At action 524, the UE 115b may retransmit the ACK to the UE 115a indicating successful decoding of the PSSCH communication transmitted to the UE 115b at action 512. The UE 115b may retransmit the ACK to the UE 115a in order to increase the probability of successful decoding of the ACK by the UE 115a.

At action 526, the UE 115a may transmit HARQ feedback indicating the ACK to the network unit 105. In some aspects, the UE 115a may transmit the HARQ feedback to the network unit 105 after the last PSFCH opportunity.

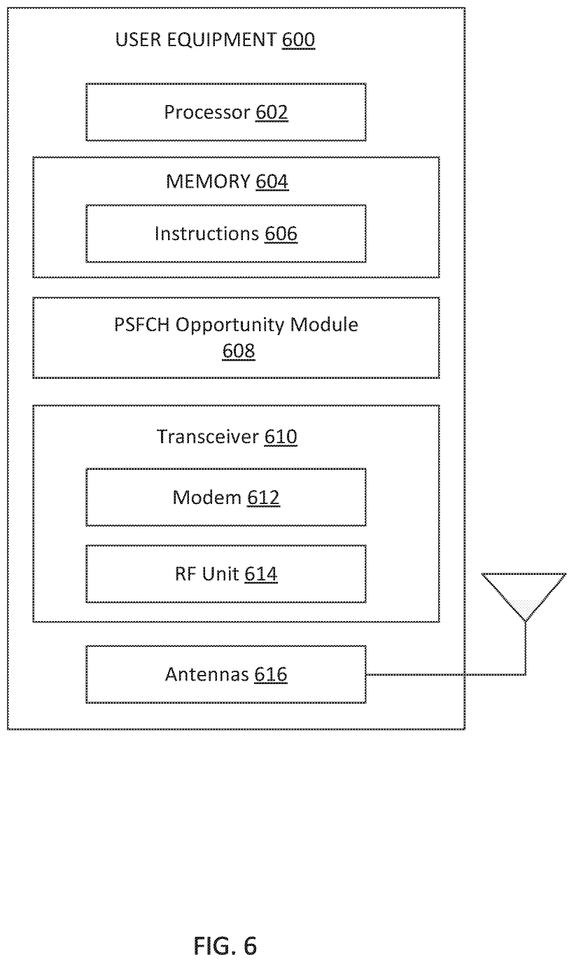

FIG. 6 is a block diagram of an exemplary UE 600 according to some aspects of the present disclosure. The UE 600 may be the UE 115 in the network 100, 200, or 300 as discussed above. As shown, the UE 600 may include a processor 602, a memory 604, a PSFCH opportunity module 608, a transceiver 610 including a modem subsystem 612 and a radio frequency (RF) unit 614, and one or more antennas 616. These elements may be coupled with each other and in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 604 includes a non-transitory computer-readable medium. The memory 604 may store instructions 606. The instructions 606 may include instructions that, when executed by the processor 602, cause the processor 602 to perform the operations described herein with reference to the UEs 115 in connection with aspects of the present disclosure, for example, aspects of FIGS. 3, 4A and 4B. Instructions 606 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The PSFCH opportunity module 608 may be implemented via hardware, software, or combinations thereof. For example, the PSFCH opportunity module 608 may be implemented as a processor, circuit, and/or instructions 606 stored in the memory 604 and executed by the processor 602. In some aspects, the PSFCH opportunity module 608 may implement the aspects of FIGS. 3-5, 8, and 9. For example, the PSFCH opportunity module 608 may perform a listen-before-talk (LBT) procedure in an unlicensed frequency band and transmit, to a second sidelink UE based on the LBT procedure being successful, an acknowledgement/negative acknowledgement (ACK/NACK) associated with a sidelink communication in at least one of a plurality of physical sidelink feedback channel (PSFCH) opportunities.

As shown, the transceiver 610 may include the modem subsystem 612 and the RF unit 614. The transceiver 610 can be configured to communicate bi-directionally with other devices, such as the BSs 105 and/or the UEs 115. The modem subsystem 612 may be configured to modulate and/or encode the data from the memory 604 and the according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data from the modem subsystem 612 (on outbound transmissions) or of transmissions originating from another source such as a UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together to enable the UE 600 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices. The antennas 616 may provide the received data messages for processing and/or demodulation at the transceiver 610. The antennas 616 may include multiple antennas of similar or different designs in order to sustain multiple transmission links. The RF unit 614 may configure the antennas 616.

In some instances, the UE 600 can include multiple transceivers 610 implementing different RATs (e.g., NR and LTE). In some instances, the UE 600 can include a single transceiver 610 implementing multiple RATs (e.g., NR and LTE). In some instances, the transceiver 610 can include various components, where different combinations of components can implement RATs.

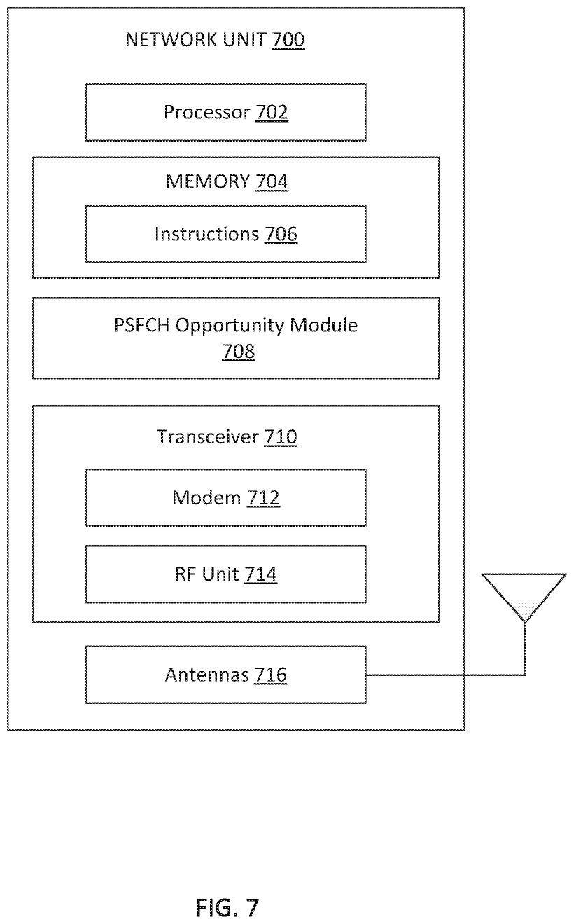

FIG. 7 is a block diagram of an exemplary network unit 700 according to some aspects of the present disclosure. The network unit 700 may be the BS 105, the CU 210, the DU 230, or the RU 240, as discussed above. As shown, the network unit 700 may include a processor 702, a memory 704, a PSFCH opportunity module 708, a transceiver 710 including a modem subsystem 712 and a RF unit 714, and one or more antennas 716. These elements may be coupled with each other and in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a

solid state memory device, one or more hard disk drives, memristor-based arrays, other forms of volatile and non-volatile memory, or a combination of different types of memory. In some instances, the memory 704 may include a non-transitory computer-readable medium. The memory 704 may store instructions 706. The instructions 706 may include instructions that, when executed by the processor 702, cause the processor 702 to perform operations described herein, for example, aspects of FIGS. 3-5.

Instructions 706 may also be referred to as code, which may be interpreted broadly to include any type of computer-readable statement(s).

The PSFCH opportunity module 708 may be implemented via hardware, software, or combinations thereof. For example, the PSFCH opportunity module 708 may be implemented as a processor, circuit, and/or instructions 706 stored in the memory 704 and executed by the processor 702.

In some aspects, the PSFCH opportunity module 708 may implement the aspects of FIGS. 3-5, 8, and 9. For example, the PSFCH opportunity module 708 may transmit, to a sidelink UE, a configuration associated with multiple PSFCH opportunities.

Additionally or alternatively, the PSFCH opportunity module 708 can be implemented in any combination of hardware and software, and may, in some implementations, involve, for example, processor 702, memory 704, instructions 706, transceiver 710, and/or modem 712.

As shown, the transceiver 710 may include the modem subsystem 712 and the RF unit 714. The transceiver 710 can be configured to communicate bi-directionally with other devices, such as the UEs 115 and/or 600. The modem subsystem 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or UE 600. The RF unit 714 may be further configured to perform analog beamforming in conjunction with the digital beamforming. Although shown as integrated together in transceiver 710, the modem subsystem 712 and/or the RF unit 714 may be separate devices that are coupled together at the network unit 700 to enable the network unit 700 to communicate with other devices.

The RF unit 714 may provide the modulated and/or processed data, e.g. data packets (or, more generally, data messages that may contain one or more data packets and other information), to the antennas 716 for transmission to one or more other devices. This may include, for example, a configuration indicating a plurality of subslots within a slot according to aspects of the present disclosure. The antennas 716 may further receive data messages transmitted from other devices and provide the received data messages for processing and/or demodulation at the transceiver 710. The antennas 716 may include multiple antennas of similar or different designs in order to sustain multiple transmission links.

In some instances, the network unit 700 can include multiple transceivers 710 implementing different RATs (e.g., NR and LTE). In some instances, the network unit 700 can include a single transceiver 710 implementing multiple RATs (e.g., NR and LTE). In some instances, the transceiver 710 can include various components, where different combinations of components can implement RATs.

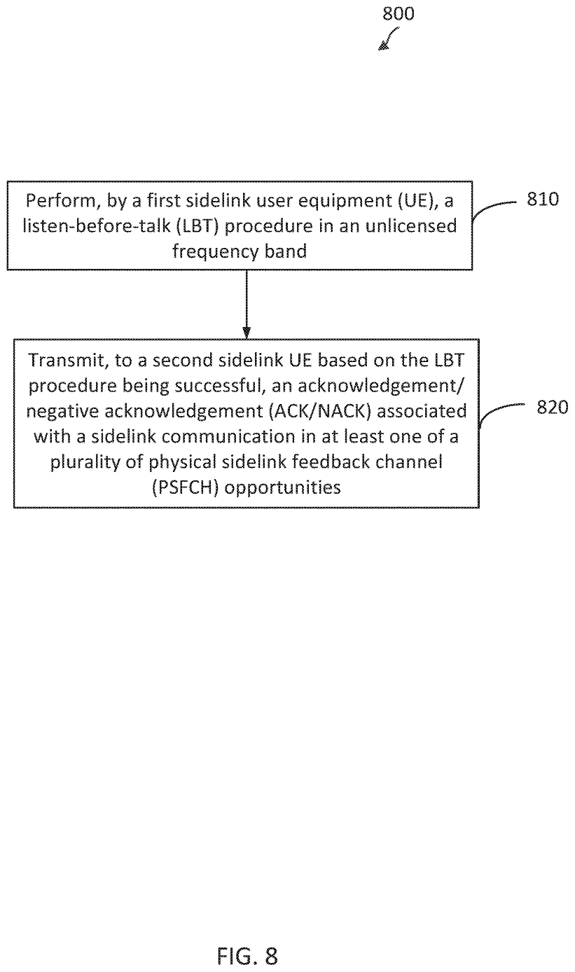

FIG. 8 is a flow diagram of a communication method 800 according to some aspects of the present disclosure. Aspects of the method 800 can be executed by a computing device (e.g., a processor, processing circuit, and/or other suitable component) of a wireless communication device or other suitable means for performing the actions. For example, a wireless communication device, such as the UE 115 or the UE 600, may utilize one or more components, such as the processor 602, the memory 604, the PSFCH opportunity module 608, the transceiver 610, the modem 612, and the one or more antennas 616, to execute aspects of method 800. The method 800 may employ similar mechanisms as in the networks 100 and 200 and the aspects and actions described with respect to FIGS. 3-5. As illustrated, the method 800 includes a number of enumerated actions, but the method 800 may include additional actions before, after, and in between the enumerated actions. In some aspects, one or more of the enumerated actions may be omitted or performed in a different order.

At action 810, the method 800 includes a first sidelink UE (e.g., the UE 115 or the UE 600) performing a listen-before-talk (LBT) procedure in an unlicensed frequency band. The first sidelink UE may perform the LBT procedure or other clear channel assessment (CCA) on one or more sidelink communication channels. In some instances, the first sidelink UE may perform an LBT procedure or other CCA to gain access to a channel occupancy time (COT) in an unlicensed (e.g., shared) frequency spectrum. For example, the first sidelink UE may perform a category 1 LBT, a category 2 LBT, a category 3 LBT, and/or a category 4 LBT to gain access to the COT in an unlicensed frequency spectrum. In some aspects, the first sidelink UE may perform the LBT in one or more time resources, spatial resources, and/or frequency resources to gain access to a channel within one or more PSFCH opportunities. The frequency resources may include a frequency spectrum, a frequency band, a frequency sub-band, a frequency subchannel, resource elements, resource blocks, and/or a frequency interlace. The time resources may include slot(s), sub-slot(s), symbol(s), subframe(s), or any other suitable time resources. In some aspects, the first sidelink UE may perform the LBT for one or more directional beams (e.g., a beam in the direction of a second sidelink UE that the first sidelink UE intends to transmit an acknowledgement/negative acknowledgement (ACK/NACK).

At action 820, the method 800 includes the first sidelink UE transmitting an acknowledgement/negative acknowledgement (ACK/NACK) associated with a sidelink communication. The first sidelink UE may transmit the ACK/NACK to a second sidelink UE based on the LBT procedure at action 810 being successful. When the first sidelink UE successfully receives (e.g., decodes) the sidelink communication, the first sidelink UE may transmit an acknowledgement (ACK) to the second sidelink UE. When the first sidelink UE does not successfully receive (e.g., decode) the sidelink communication, the first sidelink UE may transmit a negative acknowledgement (NACK) to the second sidelink UE.

In some aspects, the first sidelink UE may transmit the ACK/NACK in at least one of a plurality of physical sidelink feedback channel (PSFCH) opportunities. In some aspects, the first sidelink UE may transmit the ACK/NACK after a successful LBT.

However, in some aspects, the first sidelink UE may refrain from transmitting the ACK/NACK when the LBT fails. In order to increase the probability of the first sidelink UE performing a successful LBT and transmitting the ACK/NACK, aspects of the present disclosure provide for multiple PSFCH opportunities in which the first sidelink UE may contend for the channel and transmit the ACK/NACK.

In some aspects, the plurality of PSFCH opportunities may include a plurality of PSFCH opportunities in the time domain. For example, the plurality of PSFCH opportunities may be scheduled in multiple slots, subslots, symbols, or other suitable time periods. In some aspects, the plurality of PSFCH opportunities may include a plurality of PSFCH opportunities in a frequency domain. For example, the plurality of PSFCH opportunities may be scheduled in multiple frequency sub-bands, frequency ranges, and/or frequency subchannels. For example, referring to FIG. 3, the UE 115a may transmit the data transmission over a PSSCH 315 that corresponds to multiple PSFCH opportunities 325 including the PSFCH opportunity 325a located in the LBT sub-band 330a and in a first PSFCH symbol, the PSFCH opportunity 325b located in the LBT sub-band 330b and in the first PSFCH symbol, and the PSFCH opportunity 325c located in the LBT sub-band 330b and in a second PSFCH symbol. As such, the UE 115b may perform an LBT procedure for one or more of the PSFCH opportunities 325 to determine which of the multiple PSFCH opportunities 325 are available (e.g., which of the multiple PSFCH opportunities 325 pass LBT). In some aspects, the UE 115a may determine that one or more of the multiple PSFCH opportunities 325 are available (e.g., pass LBT) and may transmit the ACK/NACK feedback in PSFCH 320 associated with the PSSCH communication 315 over at least one of the plurality of PSFCH opportunities 325 that are available.

In some aspects, the first sidelink UE may transmit the ACK/NACK to the second sidelink UE in the earliest PSFCH opportunity of the plurality of PSFCH opportunities in which the LBT is successful. The first sidelink UE may transmit the ACK/NACK in the earliest PSFCH opportunity in order to reduce the latency in transmitting feedback to the second sidelink UE (e.g., the UE that transmitted the PSSCH to the first sidelink UE). In some aspects, the second sidelink UE may have multiple opportunities (e.g., up to two opportunities or more) to retransmit the PSSCH communication if the second sidelink UE does not receive an ACK associated with the PSSCH communication from the first sidelink UE. The second sidelink UE may not receive an ACK associated with the PSSCH communication from the first sidelink UE based on the LBT performed by the first sidelink UE not being successful, the first sidelink UE transmitting a NACK to the second sidelink UE, and/or the ACK/NACK transmitted by the first sidelink UE is not correctly received and decoded by the second sidelink UE. In some aspects, multiple PSFCH opportunities may increase the probability of the second sidelink UE receiving the ACK/NACK. For example, the first sidelink UE may transmit the ACK/NACK in the earliest PSFCH opportunity that passes the LBT and in the next (e.g., the following) PSFCH opportunity that passes the LBT. Additionally or alternatively, the first sidelink UE may transmit the ACK/NACK in a plurality of sub-bands (e.g., subchannels) of the unlicensed frequency band that passes the LBT. A sub-band may refer to or include a frequency bandwidth over which the first sidelink UE may perform an LBT procedure. For instance, in examples in which the first sidelink UE and the second sidelink UE communicate over the 5 GHZ unlicensed radio frequency spectrum band, a sub-band may refer to or include a 20 MHz frequency range or other suitable frequency range.

In some aspects, the first sidelink UE may transmit the ACK/NACK to the second sidelink UE in all of the PSFCH opportunities of the plurality of PSFCH opportunities in which the first sidelink UE performs a successful LBT. The first sidelink UE may increase the probability of the second sidelink UE successfully receiving and decoding the ACK/NACK based on transmitting the ACK/NACK in all of the PSFCH opportunities that pass the LBT. In some aspects, the second sidelink UE may combine multiple ACK/NACK transmissions from the first sidelink UE to successfully decode the ACK/NACK.

In some aspects, the first sidelink UE may receive a configuration indicating parameters associated with the plurality of PSFCH opportunities. The first sidelink UE may receive the configuration from the second sidelink UE and/or a network unit (e.g., the BS 105, the RU 240, the DU 230, the CU 210, and/or the network unit 700). The configuration may indicate the number of PSFCH opportunities, the time resources associated with the plurality of PSFCH opportunities, the frequency resources associated with the plurality of PSFCH opportunities, and other suitable parameters associated with the plurality of PSFCH opportunities. In this regard, the first sidelink UE may receive the configuration from the second sidelink UE via at least one of a radio resource control (RRC) message, a medium access control control element (MAC-CE), sidelink control information (SCI), or other suitable communication. Additionally or alternatively, the first sidelink UE may receive the configuration from the network unit via at least one of a radio resource control (RRC) message, downlink control information (DCI), a medium access control control element (MAC-CE), or other suitable communication.

In some aspects, the configuration may include a default configuration indicating parameters associated with the plurality of PSFCH opportunities. The default configuration may be adjusted (e.g., updated over time) based on parameters including, without limitation, an LBT procedure success rate, an interference level associated with the unlicensed frequency band, a buffer status report (BSR) associated with the second sidelink UE, a data type associated with the sidelink communication, a priority level associated with the sidelink communication, or other suitable parameter(s).

In some aspects, the first sidelink UE may receive an indicator indicating a subset of number of the plurality of PSFCH opportunities. The first sidelink UE may receive the indicator from the second sidelink UE and/or a network unit. The default configuration may include a default number of PSFCH opportunities and their associated time/frequency resources. The first sidelink UE may subsequently receive the indicator indicating the subset of the PSFCH opportunities. The first sidelink UE may transmit the ACK/NACK in the subset of PSFCH opportunities. The subset may be based on the parameters indicated above. For example, the first sidelink UE may measure an LBT success rate. The LBT success rate may indicate the number of times an attempted LBT is successful over a time period. The LBT success rate may reflect the level of interference/activity in the unlicensed frequency band. The first sidelink UE may transmit the LBT success rate indicator to the second sidelink UE and/or the network unit. The second sidelink UE and/or the network unit may transmit the subset of the PSFCH opportunities and their associated time/frequency resources to the first sidelink UE via at least one of a RRC message, a MAC-CE message, DCI, SCI, or other suitable communication.

In some aspects, the subset of the PSFCH opportunities may be based on a data type associated with the PSSCH communication. The data type associated with the PSSCH communication may include enhanced mobile broadband data, V2X data, massive machine type communications (mMTC) data, ultra-reliable low-latency communication (URLLC) data, and/or other types of data. The second sidelink UE may transmit the data type associated with the PSSCH communication to the network unit.

The network unit may transmit the indicator of the subset of PSFCH opportunities and their associated time/frequency resources based on the data type to the second sidelink UE via at least one of a RRC message, a MAC-CE message, DCI, or other suitable communication. The second sidelink UE may transmit the indicator of the subset of PSFCH opportunities and their associated time/frequency resources to the first sidelink UE via at least one of a RRC message, a MAC-CE message, SCI, or other suitable communication.

In some aspects, the subset of PSFCH opportunities may be based on a priority level associated with the PSSCH communication. The priority level associated with the PSSCH communication may be based on a latency requirement and/or a reliability requirement associated with the PSSCH communication. The second sidelink UE may transmit the priority level associated with the PSSCH communication to the network unit. The network unit may transmit an indicator of the subset of PSFCH opportunities and their associated time/frequency resources based on the priority level to the second sidelink UE via at least one of a RRC message, a MAC-CE message, DCI, or other suitable communication. The second sidelink UE may transmit the indicator of the subset of PSFCH opportunities and their associated time/frequency resources to the first sidelink UE via at least one of a RRC message, a MAC-CE message, SCI, or other suitable communication.

In some aspects, the first sidelink UE may receive and decode a PSSCH communication from the second sidelink UE in a first slot. The first sidelink UE may perform an unsuccessful LBT at the next PSFCH opportunity after decoding the PSSCH communication thereby preventing the first sidelink UE from transmitting an ACK to the second sidelink UE. In response to not receiving an ACK from the first sidelink UE, the second sidelink UE may retransmit the PSSCH communication to the first sidelink UE. The first sidelink UE may recognize the PSSCH communication as a retransmission and refrain from decoding the retransmitted PSSCH communication thereby reducing power consumption and computing resources. The first sidelink UE may perform an LBT at the next PSFCH opportunity after the retransmission of the PSSCH communication. If the LBT is successful at the next PSFCH opportunity, the first sidelink UE may transmit the ACK to the second sidelink UE. If the second sidelink UE successfully decodes the ACK, the second sidelink UE may refrain from retransmitting the PSSCH again. If the second sidelink does not successfully decode the ACK, the second sidelink UE may retransmit the PSSCH communication again.

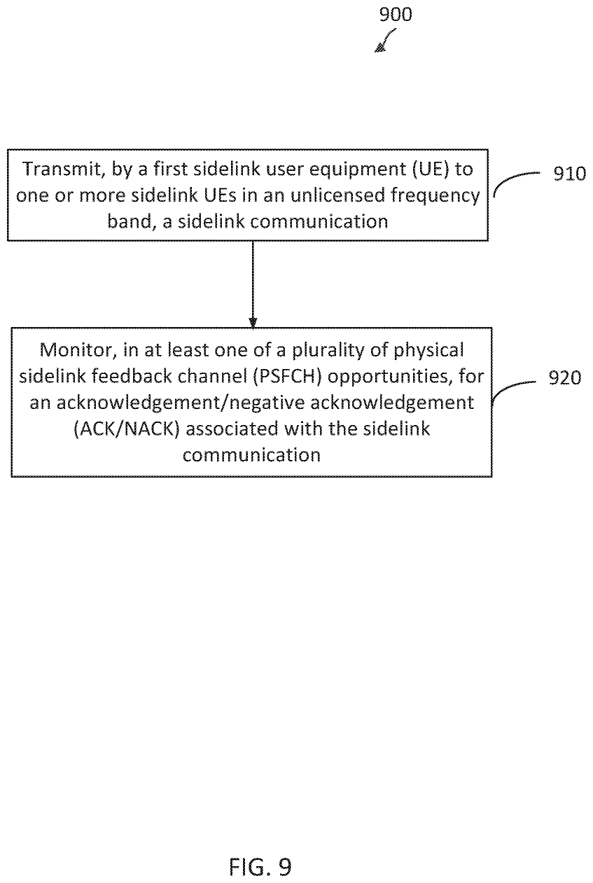

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the actions. For example, a wireless communication device, such as the UE 115 or the UE 600, may utilize one or more components, such as the processor 602, the memory 604, the PSFCH opportunity module 608, the transceiver 610, the modem 612, and the one or more antennas 616, to execute aspects of method 900. The method 900 may employ similar mechanisms as in the networks 100 and 200 and the aspects and actions described with respect to FIGS. 3-5. As illustrated, the method 900 includes a number of enumerated actions, but the method 900 may include additional actions before, after, and in between the enumerated actions. In some aspects, one or more of the enumerated actions may be omitted or performed in a different order.

At action 910, the method 900 includes a first sidelink UE (e.g., the UE 115 or the UE 600) transmitting a sidelink communication to one or more sidelink UEs in an unlicensed frequency band. In this regard, the first sidelink UE may transmit a PSSCH, a PSCCH, or other suitable sidelink communication to the one or more sidelink UEs. In some aspects, the first sidelink UE may perform a listen-before-talk (LBT) procedure in the unlicensed frequency band to gain access to the channel before transmitting the sidelink communication. The first sidelink UE may perform the LBT procedure or other clear channel assessment (CCA) on one or more sidelink communication channels. In some instances, the first sidelink UE may perform an LBT procedure or other CCA to gain access to a channel occupancy time (COT) in an unlicensed (e.g., shared) frequency spectrum. For example, the first sidelink UE may perform a category 1 LBT, a category 2 LBT, a category 3 LBT, and/or a category 4 LBT to gain access to the COT in an unlicensed frequency spectrum. The frequency resources may include a frequency spectrum, a frequency band, a frequency sub-band, a frequency subchannel, resource elements, resource blocks, and/or a frequency interlace. The time resources may include slot(s), sub-slot(s), symbol(s), subframe(s), or any other suitable time resources. In some aspects, the first sidelink UE may perform the LBT for one or more directional beams (e.g., a beam in the direction of a second sidelink UE that the first sidelink UE intends to transmit an acknowledgement/negative acknowledgement (ACK/NACK).

At action 920, the method 900 includes the first sidelink UE monitoring for an acknowledgement/negative acknowledgement (ACK/NACK) associated with the sidelink communication in at least one of a plurality of physical sidelink feedback channel (PSFCH) opportunities.

The first sidelink UE may receive the ACK/NACK from the second sidelink UE and/or other sidelink UEs. When the second sidelink UE successfully receives (e.g., decodes) the sidelink communication, the second sidelink UE may transmit an acknowledgement (ACK) to the first sidelink UE. When the second sidelink UE does not successfully receive (e.g., decode) the sidelink communication, the second sidelink UE may transmit a negative acknowledgement (NACK) to the first sidelink UE.

In some aspects, the first sidelink UE may receive the ACK/NACK based on the monitoring in at least one of a plurality of physical sidelink feedback channel (PSFCH) opportunities. In some aspects, the first sidelink UE may receive the ACK/NACK after a successful LBT is performed by the second sidelink UE. However, in some aspects, the second sidelink UE may refrain from transmitting the ACK/NACK when the LBT fails. In order to increase the probability of the second sidelink UE performing a successful LBT and transmitting the ACK/NACK, aspects of the present disclosure provide for multiple PSFCH opportunities in which the second sidelink UE may contend for the channel and transmit the ACK/NACK.

In some aspects, the plurality of PSFCH opportunities may include a plurality of PSFCH opportunities in the time domain. For example, the plurality of PSFCH opportunities may be scheduled in multiple slots, subslots, symbols, or other suitable time periods. In some aspects, the plurality of PSFCH opportunities may include a plurality of PSFCH opportunities in a frequency domain. For example, the plurality of PSFCH opportunities may be scheduled in multiple frequency sub-bands, frequency ranges, and/or frequency subchannels. For example, referring to FIG. 3, the UE 115a may transmit the data transmission over a PSSCH 315 that corresponds to multiple PSFCH opportunities 325 including the PSFCH opportunity 325a located in the LBT sub-band 330a and in a first PSFCH symbol, the PSFCH opportunity 325b located in the LBT sub-band 330b and in the first PSFCH symbol, and the PSFCH opportunity 325c located in the LBT sub-band 330b and in a second PSFCH symbol. As such, the UE 115b may perform an LBT procedure for one or more of the PSFCH opportunities 325 to determine which of the multiple PSFCH opportunities 325 are available (e.g., which of the multiple PSFCH opportunities 325 pass LBT). In some aspects, the UE 115a may determine that one or more of the multiple PSFCH opportunities 325 are available (e.g., pass LBT) and may transmit the ACK/NACK feedback in PSFCH 320 associated with the PSSCH communication 315 over at least one of the plurality of PSFCH opportunities 325 that are available.

In some aspects, the first sidelink UE may receive the ACK/NACK from the second sidelink UE in the earliest PSFCH opportunity of the plurality of PSFCH opportunities in which the LBT is successfully performed by the second sidelink UE.

The first sidelink UE may receive the ACK/NACK in the earliest PSFCH opportunity in order to reduce the latency in receiving feedback from the second sidelink UE. In some aspects, the first sidelink UE may have multiple opportunities (e.g., up to two opportunities or more) to retransmit the PSSCH communication if the first sidelink UE does not receive an ACK associated with the PSSCH communication from the second sidelink UE. The first sidelink UE may not receive an ACK associated with the PSSCH communication from the second sidelink UE based on the LBT performed by the second sidelink UE not being successful, the first sidelink UE receiving a NACK from the second sidelink UE, and/or the ACK/NACK transmitted by the second sidelink UE is not correctly received and decoded by the first sidelink UE. In some aspects, multiple PSFCH opportunities may increase the probability of the first sidelink UE receiving the ACK/NACK. For example, the first sidelink may receive the ACK/NACK in the earliest PSFCH opportunity that the second sidelink UE passes the LBT and in the next (e.g., the following) PSFCH opportunity that the second sidelink UE passes the LBT.

Additionally or alternatively, the first sidelink UE may receive the ACK/NACK in a plurality of sub-bands (e.g., subchannels) of the unlicensed frequency band that passes the LBT. A sub-band may refer to or include a frequency bandwidth over which the second sidelink UE may perform an LBT procedure. For instance, in examples in which the first sidelink UE and the second sidelink UE communicate over the 5 GHZ unlicensed radio frequency spectrum band, a sub-band may refer to or include a 20 MHZ frequency range or other suitable frequency range.

In some aspects, the first sidelink UE may receive the ACK/NACK from the second sidelink UE in all of the PSFCH opportunities of the plurality of PSFCH opportunities in which the second sidelink UE performs a successful LBT. The first sidelink UE may monitor all of the PSFCH opportunities for the ACK/NACK. The second sidelink UE may increase the probability of the first sidelink UE successfully receiving and decoding the ACK/NACK based on transmitting the ACK/NACK in all of the PSFCH opportunities that pass the LBT. In some aspects, the first sidelink UE may combine multiple ACK/NACK transmissions from the second sidelink UE to successfully decode the ACK/NACK.

In some aspects, the first sidelink UE may receive the ACK/NACK from the second sidelink UE in over or more of the PSFCH opportunities. The first sidelink UE may then transmit the ACK/NACK in a HARQ process to a network unit (e.g., the BS 105, the RU 240, the DU 230, the CU 210, and/or the network unit 700). In some aspects, the first sidelink UE may transmit the ACK/NACK to the network unit after a last PSFCH opportunity of the plurality of PSFCH opportunities. In some aspects, the first sidelink UE may transmit the ACK/NACK to the network unit after time period (e.g., a processing time period) following the earliest PSFCH opportunity of the plurality of PSFCH opportunities.

In some aspects, the first sidelink UE may transmit the sidelink communication to a group of sidelink UEs including the second sidelink UE as a groupcast sidelink communication. In this case, the second sidelink UE of the group of sidelink UEs may be configured to transmit a NACK to the first sidelink UE only if the second sidelink UE does not successfully decode the sidelink communication and refrain from transmitting an ACK if the second sidelink UE successfully decodes the sidelink communication. In this way the first sidelink UE may know that the group of sidelink UEs has successfully decoded the sidelink communication. The first sidelink UE may transmit an ACK to the network unit when the first sidelink UE does not receive a NACK from any of the sidelink UEs in the groupcast.

In some aspects, the first sidelink UE may transmit a configuration indicating parameters associated with the plurality of PSFCH opportunities to the one or more sidelink UEs including the second sidelink UE. The first sidelink UE may receive the configuration from the network unit (e.g., the BS 105, the RU 240, the DU 230, the CU 210, and/or the network unit 700) and forward the configuration to the second sidelink UE. The configuration may indicate the number of PSFCH opportunities, the time resources associated with the plurality of PSFCH opportunities, the frequency resources associated with the plurality of PSFCH opportunities, and other suitable parameters associated with the plurality of PSFCH opportunities. In this regard, the first sidelink UE may transmit the configuration to the second sidelink UE via at least one of a radio resource control (RRC) message, a medium access control control element (MAC-CE), sidelink control information (SCI), or other suitable communication. Additionally or alternatively, the first sidelink UE may receive the configuration from the network unit via at least one of a radio resource control (RRC) message, downlink control information (DCI), a medium access control control element (MAC-CE), or other suitable communication.

In some aspects, the configuration may include a default configuration indicating parameters associated with the plurality of PSFCH opportunities. The default configuration may be adjusted (e.g., updated over time) based on parameters including, without limitation, an LBT procedure success rate, an interference level associated with the unlicensed frequency band, a buffer status report (BSR) associated with the first sidelink UE, a data type associated with the sidelink communication, a priority level associated with the sidelink communication, or other suitable parameter(s).

In some aspects, the first sidelink UE may transmit an indicator to the second sidelink UE indicating a subset of number of the plurality of PSFCH opportunities. The first sidelink UE may receive the indicator from the network unit. The default configuration may include a default number of PSFCH opportunities and their associated time/frequency resources. The first sidelink UE may subsequently transmit the indicator indicating the subset of the PSFCH opportunities. The first sidelink UE may receive the ACK/NACK from the second sidelink UE in the subset of PSFCH opportunities. The subset may be based on the parameters indicated above. For example, the second sidelink UE may measure an LBT success rate. The LBT success rate may indicate the number of times an attempted LBT is successful over a time period. The LBT success rate may reflect the level of interference/activity in the unlicensed frequency band. The first sidelink UE may receive the LBT success rate indicator from the second sidelink UE. The first sidelink UE and/or the network unit may transmit the subset of the PSFCH opportunities and their associated time/frequency resources to the second sidelink UE via at least one of a RRC message, a MAC-CE message, DCI, SCI, or other suitable communication.

In some aspects, the subset of the PSFCH opportunities may be based on a data type associated with the sidelink communication (e.g., PSSCH). The data type associated with the PSSCH communication may include enhanced mobile broadband data, V2X data, massive machine type communications (mMTC) data, ultra-reliable low-latency communication (URLLC) data, and/or other types of data. The first sidelink UE may transmit the data type associated with the PSSCH communication to the network unit. The network unit may transmit the indicator of the subset of PSFCH opportunities and their associated time/frequency resources based on the data type to the first sidelink UE via at least one of a RRC message, a MAC-CE message, DCI, or other suitable communication. The first sidelink UE may transmit the indicator of the subset of PSFCH opportunities and their associated time/frequency resources to the second sidelink UE via at least one of a RRC message, a MAC-CE message, SCI, or other suitable communication.

In some aspects, the subset of PSFCH opportunities may be based on a priority level associated with the PSSCH communication. The priority level associated with the PSSCH communication may be based on a latency requirement and/or a reliability requirement associated with the PSSCH communication. The first sidelink UE may transmit the priority level associated with the PSSCH communication to the network unit. The network unit may transmit an indicator of the subset of PSFCH opportunities and their associated time/frequency resources based on the priority level to the first sidelink UE via at least one of a RRC message, a MAC-CE message, DCI, or other suitable communication. The first sidelink UE may transmit the indicator of the subset of PSFCH opportunities and their associated time/frequency resources to the second sidelink UE via at least one of a RRC message, a MAC-CE message, SCI, or other suitable communication.

In some aspects, the second sidelink UE may receive and decode a PSSCH communication from the first sidelink UE in a first slot. The second sidelink UE may perform an unsuccessful LBT at the next PSFCH opportunity after decoding the PSSCH communication thereby preventing the second sidelink UE from transmitting an ACK to the first sidelink UE. In response to not receiving an ACK from the second sidelink UE, the first sidelink UE may retransmit the PSSCH communication to the second sidelink UE. The second sidelink UE may recognize the PSSCH communication as a retransmission and refrain from decoding the retransmitted PSSCH communication thereby reducing power consumption and computing resources. The second sidelink UE may perform an LBT at the next PSFCH opportunity after the retransmission of the PSSCH communication. If the LBT is successful at the next PSFCH opportunity, the second sidelink UE may transmit the ACK to the first sidelink UE. If the first sidelink UE successfully decodes the ACK, the first sidelink UE may refrain from retransmitting the PSSCH again. If the first sidelink does not successfully decode the ACK, the first sidelink UE may retransmit the PSSCH communication again.

Further aspects of the present disclosure include the following:
Aspect 1 includes a method of wireless communication performed by a first sidelink user equipment (UE), the method comprising performing a listen-before-talk (LBT) procedure in an unlicensed frequency band; and transmitting, to a second sidelink UE based on the LBT procedure being successful, an acknowledgement/negative acknowledgement (ACK/NACK) associated with a sidelink communication in at least one of a plurality of physical sidelink feedback channel (PSFCH) opportunities.
Aspect 2 includes the method of aspect 1, wherein the plurality of PSFCH opportunities comprises a plurality of PSFCH opportunities in a time domain.
Aspect 3 includes the method of any of aspects 1-2 wherein the plurality of PSFCH opportunities comprises a plurality of PSFCH opportunities in a frequency domain.
Aspect 4 includes the method of any of aspects 1-3, wherein the transmitting the ACK/NACK comprises transmitting the ACK/NACK in an earliest PSFCH opportunity of the plurality of PSFCH opportunities.
Aspect 5 includes the method of any of aspects 1-4, further comprising retransmitting the ACK/NACK in a next PSFCH opportunity after the earliest PSFCH opportunity.
Aspect 6 includes the method of any of aspects 1-5, wherein the transmitting the ACK/NACK comprises transmitting the ACK/NACK in a plurality of sub-bands of the unlicensed frequency band.
Aspect 7 includes the method of any of aspects 1-6, wherein the transmitting the ACK/NACK comprises transmitting the ACK/NACK in all of the PSFCH opportunities of the plurality of PSFCH opportunities.
Aspect 8 includes the method of any of aspects 1-7, further comprising receiving a configuration indicating at least one of a number of the plurality of PSFCH opportunities; time resources associated with the plurality of PSFCH opportunities; or frequency resources associated with the plurality of PSFCH opportunities.
Aspect 9 includes the method of any of aspects 1-8, further comprising receiving an indicator indicating a subset of the plurality of PSFCH opportunities, wherein the transmitting the ACK/NACK comprises transmitting the ACK/NACK in the subset of the plurality of PSFCH opportunities.
Aspect 10 includes the method of any of aspects 1-9, further comprising transmitting an indicator indicating an LBT procedure success rate, wherein the indicator indicating the subset of the plurality of PSFCH opportunities is based on the LBT procedure success rate.
Aspect 11 includes the method of any of aspects 1-10, further comprising transmitting an indicator indicating at least one of a data type associated with the sidelink communication or a priority level associated with the sidelink communication, wherein the indicator indicating the subset of the plurality of PSFCH opportunities is based on at least one of the data type or the priority level.
Aspect 12 includes the method of any of aspects 1-11, wherein the receiving the indicator indicating the subset of the plurality of PSFCH opportunities comprises receiving the indicator via at least one of a radio resource control (RRC) message, downlink control information (DCI), a medium access control control element (MAC-CE), or sidelink control information (SCI).

Aspect 13 includes the method of any of aspects 1-12, wherein the receiving the indicator indicating the subset of the plurality of PSFCH opportunities comprises receiving the indicator from at least one of a network unit or the second sidelink UE.

Aspect 14 includes the method of any of aspects 1-13, further comprising receiving, from the second sidelink UE, the sidelink communication in a first slot; and refraining from decoding a retransmission of the sidelink communication in a second slot, wherein the second slot is after the first slot; and the transmitting the ACK/NACK comprises transmitting an ACK after the second slot.

Aspect 15 includes a method of wireless communication performed by a first sidelink user equipment (UE), the method comprising transmitting, to one or more sidelink UEs in an unlicensed frequency band, a sidelink communication; and monitoring, in at least one of a plurality of physical sidelink feedback channel (PSFCH) opportunities, for an acknowledgement/negative acknowledgement (ACK/NACK) associated with the sidelink communication.

Aspect 16 includes the method of aspect 15, further comprising receiving, from a second sidelink UE based on the monitoring, an ACK/NACK, wherein the one or more sidelink UEs includes the second sidelink UE; and transmitting, to a network unit, the ACK/NACK after a last PSFCH of the plurality of PSFCH opportunities.

Aspect 17 includes the method of any of aspects 15-16,, further comprising receiving, from a second sidelink UE based on the monitoring, an ACK/NACK, wherein the one or more sidelink UEs includes the second sidelink UE; and transmitting to a network unit, the ACK/NACK after a time period following an earliest PSFCH of the plurality of PSFCH opportunities.

Aspect 18 includes the method of any of aspects 15-17,, further comprising transmitting, to a network unit, an ACK based on not receiving a NACK from the one or more sidelink UEs during the monitoring.

Aspect 19 includes the method of any of aspects 15-18, further comprising receiving, from a network unit, a configuration indicating at least one of a number of the plurality of PSFCH opportunities; time resources associated with the plurality of PSFCH opportunities; or frequency resources associated with the plurality of PSFCH opportunities.

Aspect 20 includes the method of any of aspects 15-19, further comprising receiving, from the network unit, an indicator indicating a subset of the plurality of PSFCH opportunities, wherein the monitoring for the ACK/NACK comprises monitoring for the ACK/NACK in the subset of the plurality of PSFCH opportunities.

Aspect 21 includes the method of any of aspects 15-20, further comprising transmitting, to the network unit, an indicator indicating at least one of a buffer status report (BSR) or an LBT procedure success rate, wherein the subset of the plurality of PSFCH opportunities is based on at least one of the BSR or the LBT procedure success rate.

Aspect 22 includes the method of any of aspects 15-21, further comprising transmitting, to the network unit, an indicator indicating at least one of a data type associated with the sidelink communication or a priority level associated with the sidelink communication, wherein the subset of the plurality of PSFCH opportunities is based on at least one of the data type or the priority level.

Aspect 23 includes the method of any of aspects 15-22, wherein the receiving the indicator comprises receiving the indicator via at least one of a radio resource control (RRC) message, a medium access control control element (MAC-CE), or downlink control information (DCI).

Aspect 24 includes the method of any of aspects 16-23, further comprising transmitting, to the one or more sidelink UEs via at least one of a RRC message, a MAC-CE, or sidelink control information (SCI), the indicator indicating the subset of the plurality of PSFCH opportunities.

Aspect 25 includes the method of any of aspects 16-24, wherein the transmitting, to the one or more sidelink UEs, the sidelink communication comprises transmitting, to a plurality of sidelink UEs of the one or more sidelink UEs, a sidelink groupcast communication; and the monitoring for the ACK/NACK comprises monitoring for the ACK/NACK in all of the PSFCH opportunities.

Aspect 26 includes a non-transitory computer-readable medium storing one or more instructions for wireless communication, the one or more instructions comprising one or more instructions that, when executed by one or more processors of a UE, cause the UE to perform any one of aspects 1-14.

Aspect 27 includes a non-transitory computer-readable medium storing one or more instructions for wireless communication, the one or more instructions comprising one or more instructions that, when executed by one or more processors of a network unit, cause the network unit to perform any one of aspects 15-25.

Aspect 28 includes a user equipment (UE) comprising one or more means to perform any one or more of aspects 1-14.

Aspect 29 includes a network unit comprising one or more means to perform any one or more of aspects 15-25.

Aspect 30 includes a user equipment (UE) comprising a memory; a transceiver; and at least one processor coupled to the memory and the transceiver, wherein the UE is configured to perform any one or more of aspects 1-14.

Aspect 31 includes a network unit comprising a memory; a transceiver; and at least one processor coupled to the memory and the transceiver, wherein the network unit is configured to perform any one or more of aspects 15-25.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a first sidelink user equipment (UE), the method comprising:
performing a listen-before-talk (LBT) procedure in an unlicensed frequency band; and
transmitting, to a second sidelink UE based on the LBT procedure being successful, an acknowledgement/negative acknowledgement (ACK/NACK) associated with a sidelink communication in at least one of a plurality of physical sidelink feedback channel (PSFCH) opportunities.

2. The method of claim 1, wherein the plurality of PSFCH opportunities comprises a plurality of PSFCH opportunities in at least one of a time domain or a frequency domain.

3. The method of claim 1, wherein the transmitting the ACK/NACK comprises transmitting the ACK/NACK in an earliest PSFCH opportunity of the plurality of PSFCH opportunities, further comprising retransmitting the ACK/NACK in a next PSFCH opportunity after the earliest PSFCH opportunity.

4. The method of claim 1, further comprising:
receiving a configuration indicating at least one of:
a number of the plurality of PSFCH opportunities;
time resources associated with the plurality of PSFCH opportunities; or
frequency resources associated with the plurality of PSFCH opportunities.

5. The method of claim 4, further comprising:
receiving an indicator indicating a subset of the plurality of PSFCH opportunities, wherein the transmitting the ACK/NACK comprises transmitting the ACK/NACK in the subset of the plurality of PSFCH opportunities.

6. The method of claim 5, further comprising:
transmitting an indicator indicating an LBT procedure success rate, wherein the indicator indicating the subset of the plurality of PSFCH opportunities is based on the LBT procedure success rate.

7. The method of claim 5, further comprising:
transmitting an indicator indicating at least one of a data type associated with the sidelink communication or a priority level associated with the sidelink communication, wherein the indicator indicating the subset of the plurality of PSFCH opportunities is based on at least one of the data type or the priority level.

8. A method of wireless communication performed by a first sidelink user equipment (UE), the method comprising:
transmitting, to one or more sidelink UEs in an unlicensed frequency band, a sidelink communication; and
monitoring, in at least one of a plurality of physical sidelink feedback channel (PSFCH) opportunities, for an acknowledgement/negative acknowledgement (ACK/NACK) associated with the sidelink communication.

9. The method of claim 8, further comprising:
receiving, from a second sidelink UE based on the monitoring, an ACK/NACK, wherein the one or more sidelink UEs includes the second sidelink UE; and
transmitting, to a network unit, the ACK/NACK after a last PSFCH opportunity of the plurality of PSFCH opportunities.

10. The method of claim 8, further comprising:
receiving, from a second sidelink UE based on the monitoring, an ACK/NACK, wherein the one or more sidelink UEs includes the second sidelink UE; and
transmitting, to a network unit, the ACK/NACK after a time period following an earliest PSFCH opportunity of the plurality of PSFCH opportunities.

11. The method of claim 8, further comprising:
transmitting, to a network unit, an ACK based on not receiving a NACK from the one or more sidelink UEs during the monitoring.

12. The method of claim 8, further comprising:
receiving, from a network unit, a configuration indicating at least one of:
a number of the plurality of PSFCH opportunities;
time resources associated with the plurality of PSFCH opportunities; or frequency resources associated with the plurality of PSFCH opportunities.

13. The method of claim 12, further comprising:
receiving, from the network unit, an indicator indicating a subset of the plurality of PSFCH opportunities, wherein the monitoring for the ACK/NACK comprises monitoring for the ACK/NACK in the subset of the plurality of PSFCH opportunities.

14. The method of claim 13, further comprising:
transmitting, to the network unit, an indicator indicating at least one of a buffer status report (BSR) or an LBT procedure success rate, wherein the subset of the plurality of PSFCH opportunities is based on at least one of the BSR or the LBT procedure success rate.

15. The method of claim 13, further comprising:
transmitting, to the network unit, an indicator indicating at least one of a data type associated with the sidelink communication or a priority level associated with the sidelink communication, wherein the subset of the plurality of PSFCH opportunities is based on at least one of the data type or the priority level.

16. A first sidelink user equipment (UE) comprising:
a memory;
a transceiver; and
at least one processor coupled to the memory and the transceiver, wherein the first sidelink UE is configured to:
perform a listen-before-talk (LBT) procedure in an unlicensed frequency band; and
transmit, to a second sidelink UE based on the LBT procedure being successful, an acknowledgement/negative acknowledgement (ACK/NACK) associated with a sidelink communication in at least one of a plurality of physical sidelink feedback channel (PSFCH) opportunities.

17. The first sidelink UE of claim 16, wherein the plurality of PSFCH opportunities comprises a plurality of PSFCH opportunities in at least one of a time domain or a frequency domain.

18. The first sidelink UE of claim 16, wherein the first sidelink UE is further configured to:
transmit the ACK/NACK in an earliest PSFCH opportunity of the plurality of PSFCH opportunities; and
retransmit the ACK/NACK in a next PSFCH opportunity after the earliest PSFCH opportunity.

19. The first sidelink UE of claim 16, wherein the first sidelink UE is further configured to:
receive a configuration indicating at least one of:
a number of the plurality of PSFCH opportunities;
time resources associated with the plurality of PSFCH opportunities; or
frequency resources associated with the plurality of PSFCH opportunities.

20. The first sidelink UE of claim 19, wherein the first sidelink UE is further configured to:
receive an indicator indicating a subset of the plurality of PSFCH opportunities, wherein the transmitting the ACK/NACK comprises transmitting the ACK/NACK in the subset of the plurality of PSFCH opportunities.

21-30. (canceled)
